(19) United States
(12) Patent Application Publication
(10) Pub. No.: US 2018/0273047 A1
(43) Pub. Date: Sep. 27, 2018

(54) VEHICLE PROPULSION OPERATION

(71) Applicant: Ford Global Technologies, LLC, Dearborn, MI (US)

(72) Inventor: Yan Wang, Ann Arbor, MI (US)

(73) Assignee: Ford Global Technologies, LLC, Dearborn, MI (US)

(21) Appl. No.: 15/469,931

(22) Filed: Mar. 27, 2017

(51) Int. Cl. B60W 50/00; B60W 10/18; B60W 10/06; B60W 30/18; B60W 30/17

(52) U.S. Cl. CPC B60W 50/0097; B60W 10/18; B60W 10/06; B60W 30/18072; B60W 2550/30; B60W 30/17; B60W 30/18154; B60W 2710/06; B60W 2550/22; B60W 30/18109

(57) ABSTRACT

A period of time that a vehicle propulsion will be deactivated at a traffic stop is predicted. A distance for a vehicle to coast without input from the vehicle propulsion to stop the vehicle at the traffic stop is determined between the vehicle and the traffic stop when the predicted period of time exceeds a time threshold. The vehicle propulsion is deactivated when the vehicle reaches a start of the predicted distance.

### BACKGROUND

Vehicles may include computing devices that selectively deactivate a vehicle propulsion when the vehicle is stopped, e.g., at a traffic stop. This is sometimes referred to as a “stop-start” operation. By deactivating the propulsion when the vehicle is stopped, particularly when the propulsion is an internal combustion engine, the vehicle can consume less fuel. Reactivating the propulsion when the traffic stop ends can consume fuel and increase wear on vehicle parts, e.g., parts used to reactivate the propulsion, e.g., internal combustion engine.

### BRIEF DESCRIPTION OF THE DRAWINGS

FIG. 1 is a block diagram of an example system for deactivating a vehicle propulsion.

FIG. 2 illustrates an example traffic stop.

FIG. 3 is a block diagram of an example process for deactivating and reactivating the vehicle propulsion at the traffic stop.

### DETAILED DESCRIPTION

A system includes a computer programmed to predict a period of time that vehicle propulsion will be deactivated at a traffic stop, predict a distance for a vehicle to coast without input from the vehicle propulsion to stop the vehicle at the traffic stop when the predicted period of time exceeds a threshold, and deactivate the vehicle propulsion when the vehicle reaches a start of the predicted distance.

The computer can be further programmed to actuate a brake to stop the vehicle at an end of the predicted distance.

The computer can be further programmed to reactivate the vehicle propulsion when the predicted period of time expires.

The computer can be further programmed to maintain the vehicle propulsion when the predicted period of time is below the time threshold.

The computer can be further programmed to determine the predicted period of time based on data collected from another vehicle at the traffic stop.

The computer can be further programmed to determine the predicted distance based on a location of another vehicle ahead of the vehicle.

The computer can be further programmed to determine the predicted period of time based on a traffic light duration at the traffic stop. The computer can be further programmed to maintain the propulsion when a remaining portion of the traffic light duration is below a traffic light duration threshold.

The computer can be further programmed to determine the predicted distance based on a predicted deceleration of the vehicle.

The computer can be further programmed to actuate a brake when the vehicle is predicted to move past the end of the predicted distance.

A method includes predicting a period of time that a vehicle propulsion will be deactivated at a traffic stop, predicting a distance for a vehicle to coast without input from the vehicle propulsion to stop the vehicle at the traffic stop when the predicted period of time exceeds a time threshold, and deactivating the vehicle propulsion when the vehicle reaches a start of the predicted distance.

The method can further include actuating a brake to stop the vehicle at an end of the predicted distance.

The method can further include reactivating vehicle propulsion when the predicted period of time expires.

The method can further include maintaining the vehicle propulsion when the predicted period of time is below the time threshold.

The method can further include determining the predicted period of time based on data collected from another vehicle at the traffic stop.

The method can further include determining the predicted distance based on a location of another vehicle ahead of the vehicle.

The method can further include determining the predicted period of time based on a traffic light duration at the traffic stop. The method can further include maintaining the propulsion when a remaining portion of the traffic light duration is below a traffic light duration threshold.

The method can further include determining the predicted distance based on a predicted deceleration of the vehicle.

The method can further include actuating a brake when the vehicle is predicted to move past the end of the predicted distance.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

A computing device can determine a period of time that a vehicle propulsion will be deactivated upon approaching a traffic stop, e.g., an intersection with a traffic light. The computing device can determine a coasting distance between the vehicle and the traffic stop. “Coasting distance” in this context means a distance that the vehicle can move without input from the propulsion to stop at the traffic stop. The coasting distance as it is defined in the present context may be a distance at which, once propulsion is deactivated, the vehicle would simply coast to a stop given road grade, friction, etc., but could alternatively (e.g., in situations where a vehicle is close enough to a traffic stop that braking a required to stop the vehicle at the coasting distance end, e.g., because a traffic light turns yellow) be less than that distance; the coasting distance can have an end that, as defined herein, is a predetermined distance from one of a target vehicle in front of the vehicle and a stop line at the traffic stop. The coasting distance can have a start that extends from the end for a distance that is at most the predicted distance that the vehicle can move without input from the propulsion. Upon reaching the start of the coasting distance, the computing device can deactivate a propulsion, and the vehicle can move until reaching the determined end of the coasting distance. When the period of time of deactivation of the vehicle propulsion ends, the computing device can reactivate the propulsion. Alternatively or additionally, the computing device can reactivate the propulsion prior to the end of the traffic light duration when the computing device determines that additional power is required to actuate one or more vehicle components.

When the predicted period of time that the propulsion is deactivated is below the threshold amount of time, the computing device can determine not to determine the coasting distance and not to deactivate the propulsion. By determining not to deactivate the propulsion when the predicted period of time is below the threshold amount of time, the computing device can reduce fuel consumption by the vehicle and reduce wear on a propulsion starter, e.g., a starter solenoid, a crankshaft, one or more bearings, etc., caused by deactivating and reactivating the propulsion.

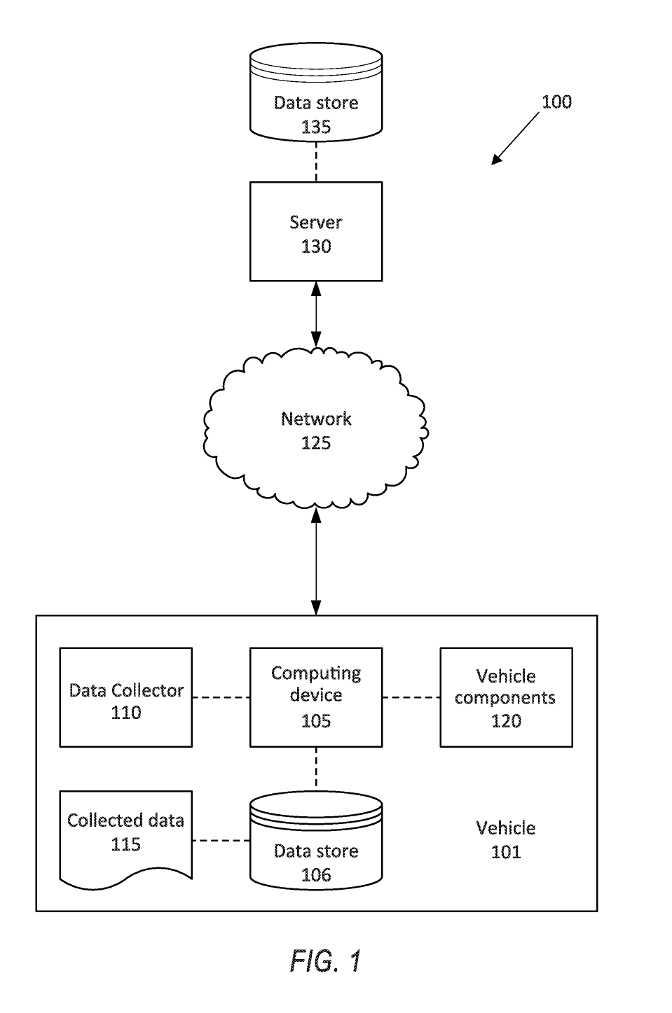

FIG. 1 illustrates an example system 100 for operating a vehicle 101 at a traffic stop. A computing device 105 in the vehicle 101 is programmed to receive collected data 115 from one or more sensors 110. For example, vehicle 101 data 115 may include a location of the vehicle 101, a location of a target, etc. Location data may be in a known form, e.g., geo-coordinates such as latitude and longitude coordinates obtained via a navigation system, as is known, that uses the Global Positioning System (GPS). Further examples of data 115 can include measurements of vehicle 101 systems and components, e.g., a vehicle 101 velocity, a vehicle 101 trajectory, vehicle 101 steering angle, accelerator and brake pedal position, etc.

The computing device 105 is generally programmed for communications on a vehicle 101 network, e.g., including a communications bus, as is known. Via the network, bus, and/or other wired or wireless mechanisms (e.g., a wired or wireless local area network in the vehicle 101), the computing device 105 may transmit messages to various devices in a vehicle 101 and/or receive messages from the various devices, e.g., controllers, actuators, sensors, etc., including sensors 110. Alternatively or additionally, in cases where the computing device 105 actually comprises multiple devices, the vehicle network may be used for communications between devices represented as the computing device 105 in this disclosure. In addition, the computing device 105 may be programmed for communicating with the network 125, which, as described below, may include various wired and/or wireless networking technologies, e.g., cellular, Bluetooth, wired and/or wireless packet networks, etc.

The data store 106 may be of any known type, e.g., hard disk drives, solid state drives, servers, or any volatile or non-volatile media. The data store 106 may store the collected data 115 sent from the sensors 110.

Sensors 110 may include a variety of devices. For example, as is known, various controllers in a vehicle 101 may operate as sensors 110 to provide data 115 via the vehicle 101 network or bus, e.g., data 115 relating to vehicle speed, acceleration, position, subsystem and/or component status, etc. Further, other sensors 110 could include cameras, motion detectors, etc., i.e., sensors 110 to provide data 115 for evaluating a location of a target, projecting a path of a target, evaluating a location of a roadway lane, etc. The sensors 110 could also include short range radar, long range radar, LIDAR, and/or ultrasonic transducers.

Collected data 115 may include a variety of data collected in a vehicle 101. Examples of collected data 115 are provided above, and moreover, data 115 are generally collected using one or more sensors 110, and may additionally include data calculated therefrom in the computing device 105, and/or at the server 130. In general, collected data 115 may include any data that may be gathered by the sensors 110 and/or computed from such data.

The vehicle 101 may include a plurality of vehicle components 120. As used herein, each vehicle component 120 includes one or more hardware components adapted to perform a mechanical function or operation—such as moving the vehicle, slowing or stopping the vehicle, steering the vehicle, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, and the like.

The computing device 105 may actuate the components 120 to, e.g., brake and/or slow and/or stop the vehicle 101, to avoid targets, etc. The computing device 105 may be programmed to operate some or all of the components 120 with limited or no input from a human operator, i.e., the computing device 105 may be programmed to operate the components 120. When the computing device 105 operates the components 120, the computing device 105 can ignore input from the human operator with respect to components 120 selected for control by the computing device 105, which provides instructions, e.g., via a vehicle 101 communications bus and/or to electronic control units (ECUs) as are known, to actuate vehicle 101 components, e.g., to apply brakes, change a steering wheel angle, etc. For example, if the human operator attempts to turn a steering wheel during steering operation, the computing device 105 may ignore the movement of the steering wheel and steer the vehicle 101 according to its programming.

When the computing device 105 operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computing device 105 and not a human operator. A semi-autonomous mode is one in which at least one of vehicle 101 propulsion (typically via a powertrain including an electric motor and/or internal combustion engine), braking, and steering are controlled at least partly by the computing device 105 as opposed to a human operator.

The computing device 105 is programmed to activate and deactivate a propulsion 120 when the vehicle 101 is stopped. That is, to reduce fuel consumption when the propulsion 120 is an internal combustion engine, the computing device 105 can deactivate the propulsion 120 when the vehicle 101 is stopped, e.g., at a traffic stop such as a traffic light, and reactivate the propulsion 120 when the vehicle 101 can move from the stop, e.g., upon display of a green traffic light, upon movement of another vehicle 101 ahead of the vehicle 101, etc. This programming can control an “engine start-stop” operation. To further reduce fuel consumption, the computing device 105 can determine the coasting distance and deactivate the propulsion at the start of the coasting distance to reduce fuel consumption when the vehicle 101 is between the start of the coasting distance and the end of the coasting distance.

Further, the computing device 105 can determine not to follow the engine start-stop operation, i.e., not to deactivate a vehicle 101 propulsion, when the period of time that the vehicle 101 will remain stationary at the traffic stop is below a threshold amount of time. By selectively suppressing the engine start-stop operation, the computing device 105 can reduce fuel consumption when the predicted amount of fuel saved by deactivating the propulsion 120 during the duration of the period of time that the vehicle 101 is stopped at the traffic stop is less than the fuel consumed by reactivating the propulsion 120. Furthermore, the computing device 105 can selectively suppress the engine start-stop operation when the predicted amount of fuel saved by deactivating the propulsion 120 at the start of the coasting distance and during the duration of the period of time that the vehicle 101 is stopped at the traffic stop is less than the fuel consumed by reactivating the propulsion 120. When the computing device 105 determines to suppress the engine start-stop operation, the wear on vehicle components 120 involved in starting the propulsion 120, e.g., a starter solenoid, caused by reactivating the propulsion during the engine start-stop operation can be reduced.

The system 100 may further include a network 125 connected to a server 130 and a data store 135. The computer 105 may further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, vehicle-to-vehicle (V2V) and vehicle-to-infrastructure (V2I) such as Dedicated Short Range Communications (DSRC), etc.), local area networks (LAN) and/or wide area networks (WAN), including the Internet, providing data communication services.

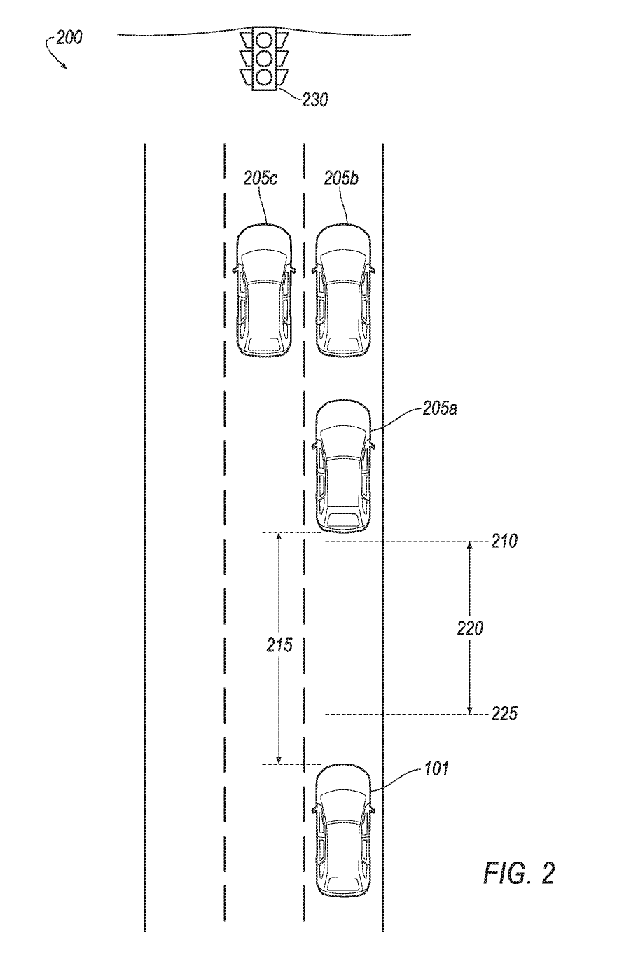

FIG. 2 illustrates an example traffic stop 200. The traffic stop 200 is a location where one or more vehicles 101 stop to allow other vehicles 101 to pass. The traffic stop 200 can include a stopping indicator, e.g., a traffic light, a stop sign, a yield sign, etc. In the example of FIG. 2, the stopping indicator is a traffic light 230.

The traffic stop 200 can include a host vehicle 101 and one or more target vehicles 205. In the example of FIG. 2, the traffic stop 200 includes three target vehicles 205a, 205b, 205c. The target vehicles 205a, 205b, 205c are stopped at the traffic stop 200, and the host vehicle 101 is moving toward the traffic stop 200. In the example of FIG. 2, the computing device 105 can actuate the vehicle components 120 to stop the host vehicle 101 behind the target vehicle 205a. Alternatively or additionally, if the host vehicle 101 is in a different roadway lane, the computing device 105 can actuate the vehicle components 120 to stop behind the target vehicle 205c or at a stop line (not shown) marked in the roadway lane.

The computing device 105 can determine a stopping point 210. The stopping point 210 is the location where the vehicle 101 is predicted to stop at the traffic stop 200. As shown in FIG. 2, the stopping point 210 is near a rear end of the target vehicle 205a. That is, the stopping point 210 can be a location a predetermined threshold from the closest target vehicle 205 in the current roadway lane and/or at a stop line (not shown) marked in the roadway lane.

The computing device 105 can determine a stopping distance 215. The stopping distance 215 is the distance from the location of the vehicle 101 to the stopping point 210. That is, upon determining the stopping point 210, the computing device 105 can actuate one or more sensors 110 (e.g., a camera) to determine the distance between the vehicle 101 and the stopping point 210.

The host vehicle 101, upon reaching the traffic stop 200 at the stopping point 210, can stop for a period of time, e.g., when a traffic light 230 shows a red light, when a target vehicle 205 is stopped in front of the host vehicle 101, etc. Based on the length of the period of time until the end of the traffic light 230 duration, the computing device 105 can be programmed to deactivate the propulsion 120 upon determining the stopping point 210 and reactivate the propulsion 120 when the traffic light 230 duration expires (e.g., a start of a green light). If the length of the period that the propulsion 120 is predicted to be deactivated is below a time threshold, the computing device 105 can determine not to deactivate the propulsion 120.

That is, deactivating and reactivating the propulsion can require additional fuel and increase wear on a propulsion starter. Thus, the computing device 105 can be programmed to deactivate and reactivate the propulsion 120 upon predicting that the fuel saved by deactivating the propulsion 120 for the period of propulsion 120 deactivation exceeds the fuel consumed by reactivating the propulsion 120 when the duration of the traffic light 230 expires. The predicted fuel consumption during reactivation of the propulsion 120 for present purposes can be determined prior to issuing the vehicle 101 into service and/or can be determined based on historical measurements of the fuel consumed during prior reactivations of the propulsion 120. That is, during each reactivation of the propulsion 120, the computing device 105 can measure the fuel consumed by the propulsion 120 and store the measurement in the data store 106 and/or the server 130. The computing device 105 can use the stored measurements to determine an average fuel consumption during reactivation of the propulsion 120, e.g., a mean fuel consumption, a median fuel consumption, etc. That is, the predicted amount of fuel consumed by the propulsion 120 from idling during the period of time until the end of the traffic light 230 duration can be compared to the fuel saved by deactivating the propulsion 120 accounting for fuel to be consumed during reactivation. The time threshold can thus be determined as the period of time where the fuel saved by deactivating the propulsion 120 is equal to the fuel consumed by reactivating the propulsion 120.

The computing device 105 can determine a start time and an end time of the traffic light 230 based on a duration of the traffic light 230. The traffic light 230 can have a light indicating “stop” (e.g., a red light), and a light indicating “go” (e.g., a green light). The traffic light 230 can have a predetermined duration for showing each of the red light and the green light. Furthermore, the traffic light 230 and/or the server 130 can communicate with the computing device 105 over the network 125, e.g., with V2I, and send a message to the computing device 105 with the duration left of the current light, i.e., the remaining time until the end time of the traffic light 230 duration. That is, the computing device 105 can receive a message over the network 125 indicating the remaining duration of the red light. Additionally or alternatively, the computing device 105 can receive a message from one of the target vehicles 205a, 205b, 205c over V2V indicating the remaining duration of the red light. Based on the remaining duration of the red light, the computing device 105 can determine the period of time of deactivation of the propulsion 120 at the traffic stop 200. If the remaining duration of the red light is below a traffic light duration threshold, the computing device 105 can determine that the host vehicle 101 will not remain at the traffic stop 200 long enough to warrant suppressing the engine start-stop operation. When the remaining portion of the traffic light duration is below a traffic light duration threshold, the computing device 105 can determine not to deactivate the vehicle propulsion 120 upon stopping at the traffic stop 200. Alternatively or additionally, the computing device 105 can determine the period of time of deactivation of the propulsion 120 based on data 115 collected by a target vehicle 205, e.g., the target vehicles 205a, 205b, 205c, and sent to the computing device 105 over V2V.

The computing device 105 can determine a coasting distance 220. The coasting distance 220 is the predicted distance that the host vehicle 101 can move upon deactivating the propulsion 120 of the host vehicle 101, i.e., without input from the propulsion 120, to stop the host vehicle 101 at the traffic stop 200. That is, the coasting distance 220 can be determined as the distance on the roadway where, upon deactivating the propulsion, the host vehicle 101 will slow to a stop, stopping before one of the target vehicles 205a, 205b, 205c or a stop line (i.e., a roadway marking indicating where the host vehicle 101 should stop at the traffic stop 200 when no target vehicles 205 are in front of the host vehicle 101). The coasting distance 220 can be determined as the current host vehicle 101 speed divided by a predicted deceleration, e.g., a predicted friction loss from drag and the roadway divided by the host vehicle 101 mass. Alternatively, the coasting distance 220 can be less than the distance at which the vehicle would slow to a stop, as described above.

By deactivating the propulsion 120, the host vehicle 101 can slow to a stop at the traffic stop 200 rather than maintaining the propulsion 120 and applying the brake 120, reducing the fuel consumption of the host vehicle 101. The coasting distance 220 can be determined based on, e.g., a predicted deceleration of the host vehicle 101 based on the vehicle 101 speed and the predicted friction coefficient of the roadway. The friction coefficient for the roadway can be stored in the data store 106 as a look-up table or the like for specific roadway materials in specific weather conditions. Alternatively or additionally, the host vehicle 101 can receive values for the friction coefficient over the network 125 from, e.g., the server 130, other vehicles 101 (including target vehicles 205), etc. The data store 106 can include friction coefficients for, e.g., asphalt, concrete, gravel, etc., for weather conditions such as dry conditions, rain, snow, ice, etc. For example, the friction coefficient for dry asphalt can be 0.65, and the friction coefficient for wet asphalt can be 0.45. Furthermore, the friction coefficient can be determined based on the vehicle 101 speed. For example, the friction coefficient for dry gravel when the vehicle 101 speed is less than 30 miles per hour can be 0.55, and the friction coefficient for dry gravel when the vehicle 101 speed is more than 30 miles per hour can be 0.50. The road condition used to determine the friction coefficient can be determined based on data 115 from one or more vehicle sensor 110, and/or can be determined based on data 115 received over the network 125 from, e.g., the server 130, other vehicles 101, etc.

The coasting distance 220 has a start 225. The start 225 is a location of the coasting distance 220 closest to the host vehicle 101 such that the coasting distance 220 ends at the stopping point 210. Thus, the start 225 can be a location that is the predicted distance that the host vehicle 101 can move upon deactivating the propulsion 120 and/or at which the host vehicle 101 is to stop with braking in addition to deactivation of propulsion, e.g., in situations where the vehicle 101 could coast further than an end, e.g., because the end is a stop line identified when a traffic light 230 turns yellow, and the vehicle 101 is closer to the traffic light 230 stop line than a distance at which the vehicle 101 would simply coast to a stop.

The computing device 105 can collect data 115 with one or more sensors 110 to determine the location of the host vehicle 101 and whether the host vehicle 101 has reached the start 225 of the coasting distance 220. As shown in FIG. 2, the start 225 of the coasting distance 220 is ahead of the host vehicle 101, so the host vehicle 101 can maintain the propulsion 120 until reaching the start 225 of the coasting distance 220, and then deactivate the propulsion 120 upon reaching the start 225 of the coasting distance 220. When the vehicle 101 reaches the start 225 of the coasting distance 220, the computing device 105 can deactivate the propulsion 120, allowing the vehicle 101 to move without input from the propulsion 120. Based on the vehicle speed and the predicted friction of coefficient of the roadway, the host vehicle 101 can stop at the stopping point 210 without additional application of the brake 120 due to, e.g., air drag and friction between the vehicle 101 tires and the roadway. That is, the start 225 can be determined such that an end of the coasting distance 220 is the stopping point 210. The computing device 105 can actuate the brake 120 at the stopping point 210 to ensure that the host vehicle 101 does not move past the stopping point 210.

Furthermore, the computing device 105 can determine that the predicted distance that the host vehicle 101 can move upon deactivating the propulsion 120 is greater than the distance between the current location of the host vehicle 101 and the closest target vehicle 205 (i.e., the stopping point 210). That is, the host vehicle 101 has already passed the start 225 of the coasting distance 220 and has not deactivated the propulsion 120, and the computing device 105 can predict that the host vehicle 101 will move past the stopping point 210. When the computing device 105 predicts that the host vehicle 101 will move past the stopping point 210, the computing device 105 can actuate the brake 120 to slow the vehicle 101 to stop at the stopping point 210.

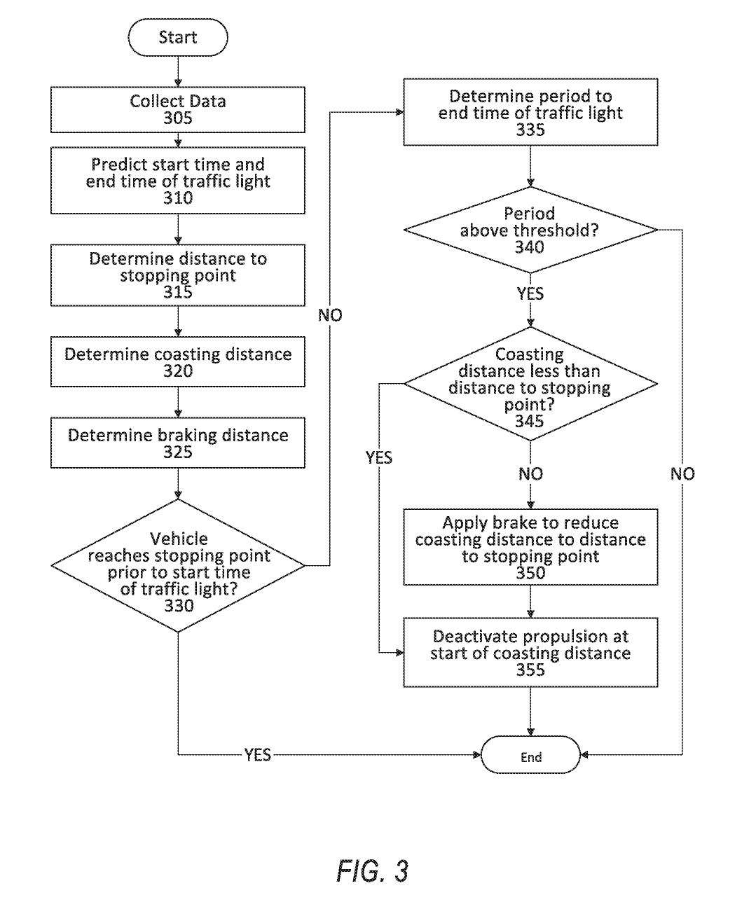

FIG. 3 illustrates an example process 300 for stopping the vehicle 101 at the traffic stop. The process 300 begins in a block 305, in which the computing device 105 collects data 115 with the sensors 110. The computing device 105 can collect data 115 about, e.g., target vehicles 205 at the traffic stop 200, a traffic light 230 at the traffic stop 200, a location of the host vehicle 101, a speed of the host vehicle 101, etc. For example, the computing device 105 can collect data 115 about a location of each of the target vehicles 205a, 205b, 205c, as shown in FIG. 2, to determine the coasting distance 220, as described above. In another example, the computing device 105 can collect data 115 about a remaining duration of the red light of the traffic light 230 to determine the period of time of deactivation of the propulsion 120.

Next, in a block 310, the computing device 105 predicts a start time and an end time of the traffic light 230. The computing device 105 can communicate with the traffic light 230 and/or the server 130 over the network 125 to predict when the red light of the traffic light 230 will start (i.e., the start time) and when the red light of the traffic light 230 will end (i.e., the end time).

Next, in a block 315, the computing device 105 determines a stopping point 210 and a stopping distance 215 between the vehicle 101 and the stopping point 210. As described above, the computing device 105 can determine a location where the vehicle 101 can stop at the traffic stop 200, i.e., the stopping point 210. The computing device 105 can then determine the distance between the current location of the vehicle 101 and the stopping point 210, i.e., the stopping distance 215.

Next, in a block 320, the computing device 105 determines a coasting distance 220 for the host vehicle 101. As described above, the coasting distance 220 is the distance that the host vehicle 101 is predicted to move upon deactivating the propulsion 120. The coasting distance 220 can be determined using known techniques based on, e.g., the current host vehicle 101 speed, a predicted air drag, a predicted friction coefficient of the roadway, etc. For example, the coasting distance 220 can be determined based on the estimated kinetic energy of the vehicle 101 and the estimated energy losses from aerodynamic drag and friction from the roadway.

Next, in a block 325, the computing device 105 determines a braking distance for the host vehicle 101. Using known techniques, the computing device 105 can determine the distance that the host vehicle 101 can move while applying the brake 120. The computing device 105 can determine the braking distance based on, e.g., the host vehicle 101 speed, the predicted friction coefficient of the roadway, etc.

Next, in a block 330, the computing device 105 determines whether the host vehicle 101 will reach the stopping point 210 prior to the start time of the red light of the traffic light 230. That is, the computing device 105 can determine whether the host vehicle 101 will reach the traffic stop 200 during the red light of the traffic light 230 and thus be required to stop. The computing device 105 can determine whether the host vehicle 101 will reach the stopping point 210 based on the data 115 collected, e.g., the vehicle 101 speed and the predicted start time of the red light of the traffic light 230. If the computing device 105 determines that the host vehicle 101 will reach the stopping point 210 prior to the start time of the traffic light 230, the computing device 105 determines that the host vehicle 101 will not stop at the traffic stop 200 and the process 300 ends. Otherwise, the computing device 105 determines that the host vehicle 101 will stop at the traffic stop 200 and the process 300 proceeds in a block 335.

In the block 335, the computing device 105 predicts a period of time until the end time of the traffic light 230. As described above, when the propulsion 120 is deactivated for the period of the time until the end time of the traffic light 230, the host vehicle 101 can reduce fuel consumption while stopping at the traffic stop 200. When the fuel saved during the period of time of deactivation of the propulsion 120 exceeds the fuel consumed from reactivating the propulsion 120 at the end of the traffic light 230, the host vehicle 101 can reduce fuel consumption. The traffic light 230 and/or the server 130 can send a message over the network 125 to the computing device 105 indicating a remaining duration of a red light. Based on the remaining duration of the red light, the computing device 105 can determine the period of time until the end time of the traffic light 230.

Next, in a block 340, the computing device 105 determines whether the predicted period of time until the end of the traffic light 230 is above a time threshold. Because deactivating and reactivating the propulsion 120 can cost additional fuel and can increase wear on a propulsion starter, the computing device 105 can be programmed to deactivate and reactivate the propulsion 120 only when the period of time is above the time threshold. As described above, operating the propulsion 120 consumes fuel, and the time threshold can be determined as the amount of time where the fuel saved by deactivating the propulsion 120 is equal to the amount of fuel consumed by reactivating the propulsion 120. If the predicted period of time is above the time threshold, the process continues in a block 345. Otherwise, the process 300 ends.

In the block 345, the computing device 105 determines whether the coasting distance 220 is less than the stopping distance 215. When the coasting distance 220 is less than the stopping distance 215, the start 225 of the coasting distance 220 is in front of the host vehicle 101, and the computing device 105 can deactivate the propulsion 120 at the start 225 of the coasting distance 220 to stop at the stopping point 210. When the coasting distance 220 is greater than the stopping distance 215, the host vehicle 101 could move past the stopping point 210 even if the propulsion 120 is immediately deactivated, and the computing device 105 can be programmed to apply the brake 120 to stop the host vehicle 101. If the coasting distance 220 is less than the stopping distance 215, the process 300 continues in a block 355. Otherwise, the process 300 continues in a block 350.

In the block 350, the computing device 105 applies the brake 120 to slow the host vehicle 101 to stop at the stopping point 210. That is, because the coasting distance 220 is based on the host vehicle 101 speed, the computing device 105 can apply the brake 120 to slow the host vehicle 101 until the predicted coasting distance 220 is less than the predicted stopping distance 215. Alternatively or additionally, the computing device 105 can apply the brake 120 prior to the stopping point 210 to stop the host vehicle 101 at the stopping point 210. The process 300 then continues in the block 355.

In the block 355, the computing device 105 deactivates the host vehicle 101 propulsion 120 upon reaching a start 225 of the coasting distance 220. As described above, upon reaching the start 225 of the coasting distance 220, the computing device 105 instructs the propulsion 120 to deactivate, allowing the host vehicle 101 to decelerate to the stopping point 210. Alternatively or additionally, the computing device 105 can actuate a brake 120 to stop the host vehicle 101 at the stopping point 210 when the computing device 105 predicts that the host vehicle 101 will move past the stopping point 210. Following the block 325, the process 300 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

Computing devices 105 generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 300, one or more of the steps could be omitted, or the steps could be executed in a different order than shown in FIG. 3. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a computer programmed to:
predict a period of time that a vehicle propulsion will be deactivated at a traffic stop;
predict a distance for a vehicle to coast without input from the vehicle propulsion to stop the vehicle at the traffic stop when the predicted period of time exceeds a threshold; and
deactivate the vehicle propulsion when the vehicle reaches a start of the predicted distance.

2. The system of claim 1, wherein the computer is further programmed to actuate a brake to stop the vehicle at an end of the predicted distance.

3. The system of claim 1, wherein the computer is further programmed to reactivate the vehicle propulsion when the predicted period of time expires.

4. The system of claim 1, wherein the computer is further programmed to maintain the vehicle propulsion when the predicted period of time is below the time threshold.

5. The system of claim 1, wherein the computer is further programmed to determine the predicted period of time based on data collected from another vehicle at the traffic stop.

6. The system of claim 1, wherein the computer is further programmed to determine the predicted distance based on a location of another vehicle ahead of the vehicle.

7. The system of claim 1, wherein the computer is further programmed to determine the predicted period of time based on a traffic light duration at the traffic stop.

8. The system of claim 7, wherein the computer is further programmed to maintain the propulsion when a remaining portion of the traffic light duration is below a traffic light duration threshold.

9. The system of claim 1, wherein the computer is further programmed to determine the predicted distance based on a predicted deceleration of the vehicle.

10. The system of claim 1, wherein the computer is further programmed to actuate a brake when the vehicle is predicted to move past an end of the predicted distance.

11. A method, comprising:
predicting a period of time that a vehicle propulsion will be deactivated at a traffic stop;
predicting a distance for a vehicle to coast without input from the vehicle propulsion to stop the vehicle at the traffic stop when the predicted period of time exceeds a time threshold; and
deactivating the vehicle propulsion when the vehicle reaches a start of the predicted distance.

12. The method of claim 11, further comprising actuating a brake to stop the vehicle at an end of the predicted distance.

13. The method of claim 11, further comprising reactivating vehicle propulsion when the predicted period of time expires.

14. The method of claim 11, further comprising maintaining the vehicle propulsion when the predicted period of time is below the time threshold.

15. The method of claim 11, further comprising determining the predicted period of time based on data collected from another vehicle at the traffic stop.

16. The method of claim 11, further comprising determining the predicted distance based on a location of another vehicle ahead of the vehicle.

17. The method of claim 11, further comprising determining the predicted period of time based on a traffic light duration at the traffic stop.

18. The method of claim 17, further comprising maintaining the propulsion when a remaining portion of the traffic light duration is below a traffic light duration threshold.

19. The method of claim 11, further comprising determining the predicted distance based on a predicted deceleration of the vehicle.

20. The method of claim 11, further comprising actuating a brake when the vehicle is predicted to move past an end of the predicted distance.
